(19) United States
(12) Patent Application Publication
(10) Pub. No.: US 2009/0068430 A1
(43) Pub. Date: Mar. 12, 2009

(54) WOOD-FIBRE HEAT-INSULATING MATERIAL AND METHOD FOR THE PRODUCTION THEREOF

(75) Inventors: Matthias Troger, Nordhausen (DE); Michael Muller, Meusegast (DE)

Correspondence Address: HARNESS, DICKEY & PIERCE, P.L.C., P.O. BOX 828, BLOOMFIELD HILLS, MI, 48303, US

(73) Assignee: HOMATHERM AG, Baar (CH)

(21) Appl. No.: 12/248,425

(22) Filed: Oct. 9, 2008

(30) Foreign Application Priority Data
Sep. 10, 2007 (DE) 10 2007 048 422.6

(51) Int. Cl. B32B 7/02; B32B 5/02; B32B 5/26; D04H 1/08; D21H 11/00

(52) U.S. Cl. 428/218; 428/338; 442/136; 442/326; 442/320; 162/141; 162/123

(57) ABSTRACT

The invention relates to a biologically degradable heat-insulating material. In order to provide an improved biologically degradable heat-insulating material, the invention proposes a biologically degradable heat-insulating material containing 50 to 90 wt. % of a cellulose and/or wood fibre having an average fibre diameter of 1 mm or less and an average fibre length of 20 mm or less, 2 to wt. % of a flame-retardant agent as well as 5 to 30 wt. % of a biologically degradable binder in the form of bico fibres having an average fibre diameter of 1 mm or less and a fibre length of 20 mm or less, wherein the density of the heat-insulating material is 30 to 300 kg/m³.

### TECHNICAL FIELD

The invention relates to a biologically degradable heat-insulating material which contains, inter alia, cellulose and/or wood fibres and bico-fibres, that is two-component fibres as binders.

The present invention further relates to a wood-fibre heat-insulating material which exhibits a heat-insulating property, a thermal stress-relieving property, a sound-damping and fire-retarding property, a fire-resistance property, a sound-damping property, preferably an ant-repelling property, a moisture regulating property, an environmental protection property and detoxification properties. The invention further relates to a method for producing a heat-insulating material by the combined application of a dry method and a semidry method.

### BACKGROUND

Wood fibre boards comprise a soft fibre board (insulating board) having a density of less than 350 kg/cm³ and produced by a wet process which uses sludge in which wood fibres, binders and size are dispersed in water, as in paper manufacture, a medium-density wood fibre board (MDF) which is produced by spraying an aqueous solution containing wood fibres, a melamine resin binder and a water-repellent agent to be applied with adhesive bonding strength, and by drying the solution by a dry method using a heating press, and furthermore a hard fibre board (hard board) having a density of 800 kg/m³ or more which is press-formed by heating at high pressure. These boards are used differently in the household as construction materials and furnishing materials.

Recently, many improved technologies have been published in connection with energy saving, reducing costs, fire protection, insect protection as well as measures for healthy living and recyclability.

For example, the unexamined Japanese Patent Publication No. 2001-334510 describes a cost-down technology whereby MDF boards having a low density are achieved whilst saving energy by forming a mixture containing wood fibres and a thermoplastic resin binder into a fleece and thermally fixing the binder at a temperature higher than its softening point.

The unexamined Japanese Patent Publication No. 2002-337116 describes a process in which MDF is dipped in an aqueous solution in which polyethylene glycol, a triazole ant repellent and ammonium phosphate in a phenol resin form a mixture in order to make the MDF flame-retardant and insect-proof.

The unexamined Japanese Patent Publication No. 2003-311717 describes a recycling method by which means recycled material having a density of 50 to 250 kg/m³ and a fineness of 0.01 to 20 mm, obtained by crushing a used wood fibre board, is mixed with the raw material of the MDF.

The unexamined Japanese Patent Publication No. 2006-289769 describes a method for producing MDF having a weight per shot of 400 to 2500 g/m² and a thickness of 2 to 50 mm by laminating a nonwoven obtained by mixing the fibre polylactate with cellulose fibre having an average fibre length of 5 to 100 mm.

The aforesaid improvement technologies pertain to the improvement technologies of an insulating board which is produced by a wet process or to those of MDF produced by a dry process, and each of these technologies corresponds to the thermal insulation, non-flammability, insect resistance, energy saving, cost reduction and the measures for recyclability but the present situation is such that no forming methods and manufacturing methods have been achieved with this, whereby the problems can be comprehensively resolved.

The present invention provides for properties such as elasticity, mechanical strength, sound damping, flame retardance and fire resistance as well as ant repellence such as have not been found previously in an insulating board produced by a wet process, even though the density range is similar to that of an insulating board produced by the wet process and the semidry process, and it improves the thermal insulation, moisture regulating property and the measure against unhealthy living and a diseased environment.

With regard to the flame-retardant and fire-resistant properties, its performance features are equivalent to or more than equivalent to a glass wool heat-insulating element and a rock wool heating insulating element and likewise with regard to the thermal insulation, a thermal stress-relieving property which delays heat transfer in an unstable state, which is not observed in a foam heat-insulating element, and a high thermal insulation are made possible by an airtight adiabatic construction.

Furthermore, used heat insulating material according to the present invention is used as fertilizer fleece in agriculture and forestry and contributes to the activation of forests and detoxification of the environment and forms a measure against global warming.

In addition, a felt-like heat insulating material according to the present invention can be subjected to a secondary utilisation by a moistening form pressing and hot forming and, when used as an ecological interior material for automobiles, contributes to the development of a new field.

### SUMMARY OF THE INVENTION

The present invention comprehensively solves the aforesaid problems by means of a heat-insulating material having a density of 300 kg/m³ or less, which is the same as that of an insulating board produced by a wet method, wherein a mixture produced by a wet method and a semiwet method is used as the main material, said mixture comprising a wood fibre having an average fibre diameter of 1 mm or less and an average fibre length of 20 mm or less and a biologically degradable binder which swells in hot water and fixes due to heat, having a fineness of 10 dtex and a fibre length of 20 mm or less.

The heat insulating material produced by the method of manufacture has a low density and elasticity and as result of the airtight adiabatic construction which uses a thermal stress-relieving property due to a low thermal conductivity and a high thermal capacity and elasticity, provides high thermal insulation and sound damping such as has not been found previously in inorganic staple fibre heat-insulating material such as glass wool or foam heat-insulating material such as extruded and expanded polystyrene.

Since the wood fibre which is treated with a flame-retardant, ant-repellent agent which is doubled with a fertilizer component, furthermore forms a carbonised heat-insulating layer against ignition by fire and heat on the surface of the heat-insulating material and is self-extinguishing, a wall element combined with a plasterboard and the like shows excellent fire-retardant and fire-resistant properties.

Since, furthermore, the raw materials of which the heat-insulating material is composed are biologically degradable and since the flameproof ant-repellent agent contains the three fertilizer elements for plant cultivation, they can be used, including the waste from used insulating materials, as fertilizer material without any loss due to transplanting. They also exhibit an environmental cleaning function which contributes to accelerated growth of seeds activation of forests, reduction of CO2 and prevention of global warming.

Raw materials which are combined in a heat-insulating material according to the invention as well as their product forms and method of manufacture are described in detail hereinafter.

### BRIEF DESCRIPTION OF THE DRAWING

FIG. 1 is a flow chart of the preferred method of the invention.

### DESCRIPTION OF THE PREFERRED EMBODIMENTS

Wood fibre forming the heat-insulating material according to the invention is obtained by treatment of thin timbers such as conifers, for example, silver fir, Asibrica, Japanese larch, cedar and spruce and broad-leaved trees such as beech, maple and sawtooth oak; wood chips from old timbers and ground tough bark of bamboo, hemp and the like with flame-retardant ant-repellent agents, doubled with a fertiliser component, and fibrillation thereof.

The wood chips and ground products are obtained by cutting timbers into the form of thin pieces having a length of 10 to 30 mm and a width of 5 to 15 mm and treatment thereof with a refining agent described subsequently.

The wood chips and ground products treated with a flame-retardant ant-repellent agent are treated with steam and softened by steam or the like, and then shredded by a refiner so that they have an average fibre diameter of 1 mm or less and an average fibre length of 20 mm or less, and further processed into wood fibres. The reason for an average fibre diameter of 1 mm or less is to ensure elasticity of the heat-insulating material obtained and to reduce its thermal conductivity. The reason for an average fibre length of 20 mm or less is to suppress granulation of adjacent fibres and the production of fluffs during a mixing step with a fibrous binder described subsequently in a dry process and the uniform mixing thereof by dispersion. Uniform dispersion is appropriate in a range of 10 to 300 L/D (fibre length/fibre diameter) and the fibre length is preferably 20 mm or less.

The flame-retarding ant-repellent agent doubled with a fertiliser component which is the main component of the heat-insulating material of the present invention is mixed in a state in which a dip treatment of the wood fibre is carried out. The flame-retarding ant-repellent agent doubled with a fertiliser component gives the heat-insulating material according to the present invention a flame retardance and non-flammability and a composite element with a plaster board and the like, a fire-retardant and fire-resistant property and it provides for an ant-repelling property as a measure against termite erosion. Furthermore, the flame-retarding ant-repellent agent is doubled with a fertiliser component which can be used as a fertiliser fleece and as matting for the cultivation of seedlings in agriculture and contains used heat insulating material. The flame-retarding ant-repellent agent doubled with a fertiliser component is a mixture of a boron compound and a phosphorus compound and especially contains boric acid, borax, borosilicate, ammonium polyphosphate, ammonium dihydrogen phosphate, magnesium polyphosphate, potassium polyphosphate, sodium hypophosphite and sodium sulphite as solution aid and potassium carbonate and magnesium chloride as fixing aid. If an immersion-adherent quantity for the wood fibre is 2 wt. % or less, the flame-retardant effect and the ant-repellent effect are inadequate and at 30 wt. % or more, a saturation effect occurs, which results in increased expense which is why 2-30 wt. % is considered to be appropriate.

The biologically degradable binder forming the main component of the heat-insulating material according to the invention is a natural and synthetic binder and comprises a mixture of hot-water-soluble adhesive binder which is suitable for a wet method and for a semidry method and a hydrophobic thermally fixing binder and is restricted to a biologically degradable binder in fibre form.

The natural and the synthetic hot-water-soluble binder contains a natural starch, cellulose derivative and chitosan and the hot-water-soluble binder contains ideally saponified polyvinyl alcohol, a silicon-containing polyvinyl alcohol and the like. It corresponds to a binder that is fibre-supported, for example, by wood fibres or a fibrous binder.

The synthetic hydrophobic thermally fixing binder contains polycaprolactam polyamide, polylactic acid, aliphatic polyester resins such as polybutylene succinate, polybutylene succinate adipate and a biologically degradable polyethylene polypropylene composite resin that is fibrous.

The fibrous binder is restricted to a fibre-supported type of binder, having a fineness of 10 dtex or less and a fibre length of 20 mm of less, or to a fibrous binder in order to ensure homogeneous mixing of the raw material by dispersion, the degree of fineness of the mixture and the property of a flaky deposit and a distribution in the dry method and the semidry method which are the forming methods of the present invention.

The main component of the composition according to the present invention comprise the wood fibres, the flame-retardant ant-repellent, doubled with a fertilizer component and the biologically degradable hot-water soluble and thermally fixing fibrous binder which has been explained previously. A suitable mixture can be produced from environmentally friendly additives such a water-repellent fluorochemical agent, a water-repellent silicone oil agent, alkyl ketene dimer as bonding agent, an anti-bacterial agent in which antibacterial substances such as copper and zinc [using] calcium phosphate as carrier and fungicides such as hinokitiol and chitosan as further additives.

A fleece and a light-weight building board made of the heat-insulating material according to the invention can be produced by a method in which the dry method and semidry method described hereinafter are used in combination, wherein this fleece and this light-weight building board differ from the insulating board produced by a wet method and by the MDF board produced by a dry method.

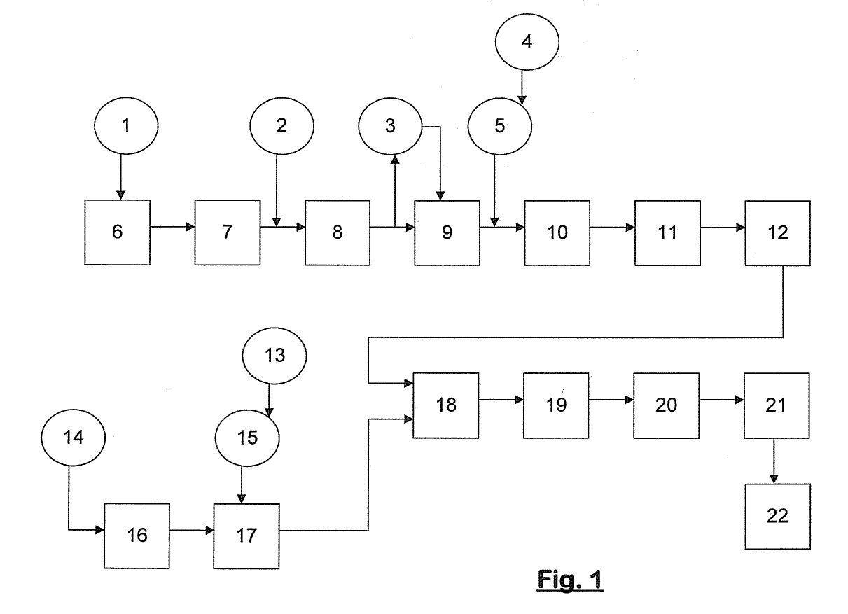

The method of manufacture according to the present invention is shown in the flow diagram in FIG. 1.

Wood chips 1 having a length of 15 to 25 mm, a width of 5 to 10 mm and a thickness of 2 to 5 mm, obtained by peeling the outer tree bark of thin timbers and old timbers of conifers and broad-leaved trees which are dipped at 6 in an aqueous solution or suspension containing a boron compound and a phosphorus compound at a normal temperature of up to 80° C. for a duration of 2 to 24 hours, are treated with steam at a vapour pressure of 0.5 to 1 MPa for a duration of 5 to 20 minutes and at 8 are successively defibrillated using a single- or two-disk refiner. The average fibre diameter, the average fibre length and the output rate of the wood fibres can be controlled by varying the rotational speed of the refiner and by varying the distance between the fixed blades and the rotating blades. A first binder 2 that is biologically degradable can optionally be added to the wood chips 1.

The wood fibre treated at 7 with a flame-retardant ant-repellent doubled with fertilizer component, which is produced in a refining step, is temporarily packaged by compressing as a flock bale which is moistened if necessary at 9 with a moisture content of 15 wt. % or it is fed to a drum screen in a next step for mixing by dispersion.

The drum screen which mixes the wood fibres 3, the biologically degradable binder 5 and other additives 4, is a conical trapezoidal rotator having a metallic mesh network at its outer periphery. The supplied raw materials of the heat-insulating material are agitated continuously and mixed in the direction of an outlet opening at 10 and dispensed due to the difference between the peripheral velocities of the feed opening on the smaller diameter side and the outlet opening on the larger diameter side. The product which has been comminuted in this step is separated from the raw materials and removed to the outer periphery by the metal network.

The raw materials of the heat-insulating material which have been mixed and dispersed by the drum screen are transported by pneumatic conveyance at 11 into a chamber for collecting the flaky deposit, which has a mesh strip provided with a suction device on the back and these materials are collected by a dry method in order to be formed into thick fleeces. These fleeces are then transferred onto a continuous conveyor belt and then brought into a state having approximately fixed thickness and density by form pressing at 12 and then a binder 5 comprising a fibrous hot-water soluble binder is made to swell by moisture to bind the fibres to one another and to give the fleeces a shape stability property and elasticity. In the semidry method the density of the upper and lower layer of the fleece is increased to more than the density of an intermediate layer by carrying out a further high-pressure drying and a three-layer structure having different densities is formed.

The fibrous binder 5 is then thermally fixed whilst it is subjected to a press forming with a mobile conveyer by the drying method and the fleece acquires the form of the end product having strength and elasticity. The fibrous binder 5 is provided, for example, by bico fibres.

The fleece and the board produced from the heat-insulating material by the dry method and the semidry method have a good appearance, are uniform and possess strength in a thickness direction; they have a heat-insulating property (low thermal conductivity), are flame-retardant and fire-resistant, have an ant-repelling effect, are sound-damping, moisture-regulating, VOC-free and possess the properties of a fertilizer material.

The felt from the heat-insulating material according to the invention can be produced by the energy-saving dry method described subsequently.

The felt of the present invention is a felt obtained by manufacturing the paper by a dry method from a mixture containing the previously described composition, by forming a felt having a thickness of 2 to 10 mm and a density of 200 to 300 kg/m³ by the aforesaid wet adhesion and thermally fixing adhesion, by laminating a commercially available biologically degradable nonwoven onto one or both sides of the felt and by needling, wherein the felt acquires a fixed length or is rolled up.

The felt can be produced by a similar method as in paper manufacturing but for reasons of saving energy and saving costs during manufacture, it is advantageous to produce the paper by the dry method and the semidry method.

In a wet method similar to the paper manufacturing method, a felt having a thickness of 2 to 10 mm can be produced by a circular network, long network or funnel forming system using an aqueous sludge in which the aforesaid raw materials of the heat-insulating material are distributed with a concentration of 1 to 5 wt. %.

In the dry method which includes dry paper manufacture, the raw materials of the heat-insulating material are dispersed by the air flow of the air laying system which has been developed by M&J Fibertech Co. in Denmark, and Danweb Co and can be formed into a felt having a thickness of 2 to 10 mm.

The felt is preliminarily dried in the wet method but the felt is adjusted to a moisture content of about 15 wt. % by moistening with steam in the dry method. In a subsequent step, the fibres are adhesively bonded to one another by the wet adhesion and by thermally fixing adhesion of the fibrous binder of the felt in order to form a soft-elastic felt similar to that in the dry method and in the semidry method.

In order to make the felt manageable, a commercially available fibre material having a weight per shot of 20 to 100 g/m² (e.g. TERRAMAC from Unitika Ltd.) is laminated onto one or both sides of the felt, needled and finally processed to a felt which in practice has a strength such that it can be rolled up.

The finished heat-insulating material 22 can finally be formed as board which ultimately consists of a fleece which can be laid with felt on one or the other end side. The felt can be formed from the initial materials wood fibres 14, biologically degradable binder 15 and optionally additives which are processed in the dry method at 16 and further processed at 17 to give felt. The previously formed fleece is combined with the formed felt wherein a moistening and hot forming by the semidry method can take place in a first step 18 and a hot forming by the dry method in a second step 19. Finally, a moisture regulating and curing step can be carried out at 20 and optionally a step involving cutting and final processing to form the thermal product 22 can be provided at 21.

The present invention is now described hereinafter with reference to examples which, however, do not restrict the invention.

### Example 1

### Wood Fibre

The bark of dried, thin timbers such as Asibrica, Japanese larch and cedar was removed and wood chips having a length of about 20 mm, a width of about 15 mm and a thickness of 2 mm were dipped in the hot water solutions for a duration of 24 hours:
1) Aqueous suspension solution containing 10 wt. % boric acid, 2 wt. % borax, 1 wt. % potassium phosphate and 10 wt. % ammonium polyphosphate and
2) Aqueous solution containing 10 wt. % boric acid, 1 wt. % potassium carbonate and 15 wt. % ammonium dihydrogen phosphate.

The treated wood chips were damped at a steam pressure of 1 MPa for a duration of 10 minutes, fed into a double-disk refiner and fibrillated at a rotational speed of 800 rpm and a spacing of 2 mm, wherein however a powdery binder is added at this time if this is necessary (described subsequently). The moisture treatment was then carried out to produce a wood fibre which is treated with a flame-retardant ant repellent doubled with a fertilizer component and which has an average fibre diameter of 0.2 mm and a fibre length of 20 mm. Codes which are given in the following Table 1 were provided for the wood fibres obtained from the different trees and using the different treatment solutions.

TABLE 1
Code abbreviations for wood fibres treated with flame
retardant ant repellents doubled with a fertilizer
component.

| Type of tree | Treatment agent 1 | Treatment agent 2 |
|---|---|---|
| Asibrica | A-1 | A-2 |
| Japanese larch | B-1 | B-2 |
| Cedar | C-1 | C-2 |

Fibrous Binder

Poval resin powder having an ideal degree of saponification (POVAL V-20) manufactured by JAPAN VAM & POVAL Co. Ltd.) was mixed with the wood fibres (A-1 and A-2) with a fraction of 10 wt. % in powder form to produce a powdery binder (1) which was combined with the wood fibres coated with Poval resin. Fibrous binder of hot-water soluble Poval fibre (VINYLON VPB, made by Kuraray Co., Ltd) (2) having a fineness of 5 dtex and a cut length of 20 mm, a biologically degradable thermally fixing polyolefin composite fibre (ES FIBER VISION, biologically degradable ES fibre) (3) having a fineness of 3 dtex and a cut length of 20 mm were mixed in a ratio by weight of (1):(3)=5:1 (Code D) and a ratio by weight of (2):(3)=1:1 (Code E) in order to produce the fibrous binders D and E.

Fleece Formation

Mixtures in which the wood fibres A, B and C and the fibrous binders D and E were weighted with the mixture formation ratios of Table 2 were fed into a rotating drum screen having a metal network with punching 7, in which the peripheral velocity of a feed opening was 0.5 m/s and the peripheral velocity of an outlet opening was 0.8 m/s, and were dispersed by mixing. During the dispersion which takes place due to rotation, the mixtures move from the feed opening to the outlet opening but the pulverised parts of the raw material mixture were removed.

The raw materials distributed homogenously due to the mixing were conveyed by pneumatic conveyance to a collection chamber (a device for flock deposition, comprising a continuously moving continuous mesh network conveyer, which is fitted with a rear suction box) and were then collected and laminated to form homogeneous and thick fleeces. The thick fleeces were transported to a reciprocating double conveyor of a continuously moving conveyor plate and arranged there, and a form pressing of the fleeces to an approximately solid thickness was carried out by the dry method which includes the step of changing the distance between the reciprocating conveyors.

Fleece Binding

The fleece was transported forwards and backwards to a divided zone on the double conveyor, the fibrous binders were laminated wet with the wood fibres in a temperature range of 70 to 100° C. by the semidry method by which steam was expelled from the reciprocating conveyors, and formed manageable primary fleeces were produced.

The formed primary fleeces were then finish-processed to given heat-insulating materials having suitable strength and elasticity whereby the fleeces were heated by the dry method whereby a hot air flow was expelled from the reciprocating conveyor whilst they were compressed to their final thickness in a subdivided zone as in the previous step and whereby the fibrous binders were thermally fixed in a temperature range of 100 to 150° C.

Evaluation of the Efficiency of the Heat-Insulating Material Produced for the Tests

The mixture formation ratio, the thickness and density of the wood fibres, the flame-retardant ant-repellent agent and the fibrous binders were varied in the aforesaid methods in order to produce the heat-insulating materials according to Table 2.

TABLE 2
Mixture formation ratio, thickness and density of
heat-insulating materials

| | | | Mixture | | |
|---|---|---|---|---|---|
| | | | formation | | |
| | | | ratio | Heat-insulating | |
| | | | (wt. %) | material | |
| Test | Composition material | | Wood | Thickness | Density |
| sample No. | Wood fibre | Binder | fibre:binder | (mm) | (kg/m³) |
| 1 | A-1 | D | 90:10 | 50 | 55 |
| 2 | A-1 | E | 90:10 | 50 | 55 |
| 3 | A-1 | D | 80:20 | 50 | 55 |
| 4 | A-2 | E | 80:20 | 50 | 55 |
| 5 | B-1 | D | 90:10 | 50 | 40 |
| 6 | B-2 | E | 90:10 | 50 | 80 |
| 7 | C-1 | D | 90:10 | 25 | 160 |
| 8 | C-2 | E | 90:10 | 25 | 160 |

The thermal conductivity of the heat-insulating material from Table 2 was measured in each case in accordance with the board direct method according to JIS-A-1412 and the specific thermal capacity was measured by Kohlrausch liquid calorimetry.

The elastic restoring properties of the heat-insulating material were evaluated according to elasticity ((A): good, (B): normal and (C): poor recovery)) and according to the restoring rate (%). The results obtained are given in Table 3.

TABLE 3
Efficiency of heat-insulating material according to the
present invention

| | Thermal | Specific | Mechanical Properties | |
|---|---|---|---|---|
| Test sample | conductivity | heat | | Restoring |
| No. | (W/mK) | (J/kgK) | Elasticity | property |
| 1 | 0.038 | 2080 | (A) | 100% |
| 2 | 0.038 | 2080 | (A) | 100% |
| 3 | 0.038 | 2080 | (A) | 100% |
| 4 | 0.038 | 2080 | (A) | 100% |
| 5 | 0.039 | 2070 | (A) | 100% |
| 6 | 0.039 | 2090 | (A) | 100% |
| 7 | 0.040 | 2100 | (B) | 100% |
| 8 | 0.040 | 2100 | (B) | 100% |

The heat-insulating materials manufactured for the tests showed a good result with regard to thermal insulation and elasticity according to Table 3.

### Example 2

Samples Nos. 1 and 2 from Example 1 were cut to a size of 10 cm×10 cm×2 cm and four sides and their base was coated with an aluminium foil to prepare sample bodies. The flame-retarding properties of the sample bodies were evaluated in accordance with CCM (cone calorimetry) with reference to the public bulletin No. 9, Article 2 of the Building Standards Law and the result was 5.2 MJ/10 min and 6.5 MJ/20 min and they were certified as quasi-flammable and flammable.

### Example 3

### Comparison of the Heat-Insulating Effect of the Heat-Insulating Material Manufactured for the Tests with Those of Glass Wool Heat-Insulating Material

The heat-insulating effect of heat-insulating material No. 6 from Example 1 having a density of 80 kg/m³ was compared with that of a glass wool heat-insulating material having a density of 16 kg/m³ and the result is shown in Table 4.

TABLE 4
Comparison of the heat-insulating effect of the
heat-insulating material manufactured for the tests with
that of glass wool heat-insulating material

| Heat- | | Thermal | | Thermal | Mechanical property | |
|---|---|---|---|---|---|---|
| insulating | Density | conductivity | Specific heat | diffusivity | | Restoring |
| material | (kg/m³) | (W/mK) | (J/kgK) | (cm²/k | Elasticity | property |
| Heat- | 80 | 0.038 | 2000 | 10 | (A) | 100% |
| insulating | | | | | | |
| material | | | | | | |
| according | | | | | | |
| to the | | | | | | |
| invention | | | | | | |
| Glass wool | 16 | 0.038 | 1000 | 60 | (C) | 100% |
| heat- | | | | | | |
| insulating | | | | | | |
| material | | | | | | |

It can be seen from Table 4 that the thermal conductivity which shows the degree of heat transfer under a stable state (environment in which the external temperature does not change) of the heat-insulating material manufactured for the tests, is the same as that of the glass wool heat-insulating material but the thermal diffusivity which shows the heat transfer under an unstable state (environment in which the external temperature changes) is only ⅙ and the heat transfer in an environment with varying external temperature is reduced substantially.

### Example 4

### Comparison of the Sound Damping of the Heat-Insulating Material Manufactured for the Tests with that of Glass Wool Heat-Insulating Material

For heat-insulating material No. 2 manufactured for the tests from Example 1 which has a density of 55 kg/m³ and a thickness of 50 mm and for the glass wool heat-insulating material which has a density of 48 kg/m³ and a thickness of 50 mm, the sound damping rate according to the Nachhall method in accordance with JIS A-1049 was measured under conditions of adhesion to a rigid wall without an air layer on the rear side and the result is shown in Table 5.

TABLE 5
Comparison of the sound damping of the heat-
insulating material manufactured for the tests with that of
glass wool heat-insulating material

| Heat- | | | | | | |
|---|---|---|---|---|---|---|
| insulating | Frequency | | | | | |
| material | 125 Hz | 160 Hz | 200 Hz | 250 Hz | 500 Hz | 1000 Hz |
| Heat- | 16% | 39% | 65% | 84% | 100% | 100% |
| insulating | | | | | | |
| material | | | | | | |
| according to | | | | | | |
| the | | | | | | |
| invention | | | | | | |
| Glass wool | 16% | 35% | 48% | 60% | 95% | 100% |
| heat- | | | | | | |
| insulating | | | | | | |
| material | | | | | | |

As can be seen from Table 5, compared with the glass wool insulating material, the heat-insulating material manufactured for the tests has a good sound damping effect in a low frequency range, which shows elasticity.

### Example 5

### Evaluation of the Fire Resistance Effect and Sound Damping Effect of the Heat-Insulating Material Manufactured for the Tests

The two layers of the heat-insulating material No. 4 from Example 1, manufactured for the tests were inserted in a slightly large dimension between two wooden stamps of a test frame with wood axes having a body difference of 100×100 mm, a post of 100×100 mm and a wooden stamp of 100×50 mm and were adhesively bonded with a heat expansion board (BLGR) manufactured by MARUSAN PAPER MFG. CO., LTD.) mixed with graphite having a thickness of 2 mm, and the stamp spacing was 455 mm, and the fire resistance effect and the sound damping effect of a partition wall clad with plasterboard having a thickness of 12.5 mm on both sides was evaluated.

The fire resistance effect was determined by carrying out the fire resistance test in accordance with Public Bulletin No. 1358 of the Building Ministry with reference to the standard fire curve ISO 834. The result was an average temperature of 132° C. and a maximum temperature of 145° C. on the non-heated front side and this was approved as semi-fire-resistant for 45 minutes.

Furthermore, the sound transmission loss of the board was measured by the Nachhall method in accordance with JIS A-1419. The result shows a good sound damping effect in the sound damping class D-50.

### Example 6

### Evaluation of the Moisture Regulating Effect of the Heat-Insulating Material Manufactured for the Tests

The heat-insulating materials Nos. 4, 6 and 8 from Example 1 manufactured for the tests were cut to 100×100 mm and had four sides and their back faces were sealed with an aluminium adhesive strip. They were dried for 24 hours at 45° C. and then cured at 25° C. and 50% RH for a duration of 72 hours in order to measure the moisture-absorbing and moisture-releasing effect.

The measurement conditions for the moisture-absorbing and the moisture-releasing effect comprised moisture absorption at 25° C. and 90% RH for 24 hours and then moisture release at 25° C. and 50% RH over 24 hours, which corresponded to one cycle. Three cycles were carried out. The moisture absorption and the moisture release were measured and the result is shown in Table 6.

TABLE 6
Moisture regulating effect of heat-insulating
material according to the invention

| Heat-insulating | Amount of moisture | Amount of moisture |
|---|---|---|
| material | absorption (g/m²) | release (g/m²) |
| No. 1 | 297 | 291 |
| No. 2 | 411 | 406 |
| No. 3 | 403 | 398 |

Table 6 shows that the materials absorb and release moisture according to the ambient temperature and that they exhibit a moisture regulating effect which is the same as or higher than that of a spruce material.

It was furthermore established that although the surface feels slightly moist in a moisture-absorbing state, it has no dew condensate and the surface feels smooth and dry in a moisture-releasing state. Thus, no fungus forms and the problem of fungal growth is resolved.

### Example 7

### Evaluation of the Impact Sound Insulation of the Heat-Insulating Material Manufactured for the Tests

The heat-insulating material No. 4 from Example 1 having a thickness of 50 mm was provided by insertion between support beams on a floor (A), and wherein to give realism, a 50 mm thick floor covering material of wood under high tension was provided on the surface of the exposed support beam so that the gap between the top side of the support beam and the heat-insulating material was an air layer and in addition, a 12.5 mm thick plasterboard was provided as a layer on the underface of the support beam to create a floor (B). The floor was acted upon by a bag machine and the damped impact noise was measured in a corresponding lower room.

The measurement method was carried out in accordance with JIS A-1418 (measurement of the impact sound level in a building). The impact sound level of the floor (B) was 50 dB and it showed a good impact sound damping effect whereas the impact sound level of the floor (A) was 71 dB.

### Example 8

### Evaluation of the Ant Repulsion of Heat-Insulating Material

Testing for damage by house termite erosion (Coptoternus Formasanus) was carried out in an environment of 25° C. and 75% RH for one month using sample bodies (n=3), which were produced by cutting to a size of 2×2×2 cm heat-insulating material No. 4 from Example 1 manufactured for the tests and having a density of 55 kg/m³, the foamed polystyrene heat-insulating material produced by extrusion and having a density of 28 kg/m³ and a glass wool heat-insulating material having a density of 16 kg/m³. The ant repellent effect was determined by reference to the weight reduction rate ((A): 5% or less, (B): 5 to 10% and (C): 10% or more) and by visual observation ((A): good; (B): some damage was determined but this was slight, and (C) more severe damage was determined). The result is shown in Table 7.

TABLE 7
Evaluation of the ant repellence of heat-
insulating material according to the present invention

| Heat-insulating | | |
|---|---|---|
| material | Weight reduction | Visual observation |
| Heat-insulating | (B) | (B) |
| material according to | | |
| the invention | | |
| Glass wool heat- | (B) | (B) |
| insulating material | | |
| Extruded foamed | (C) | (C) |
| polystyrene heat- | | |
| insulating material | | |
| Cedar | (C) | (C) |

The heat-insulating material manufactured for the tests did not show any 100% ant-repellent effect different to the glass wool heat-insulating material but showed a comparable ant-repellent effect. Consequently it was found that an effective measure for repelling ants is possible due to a combination with foamed glass having an ant-repelling effect and by partial coating with an ant repellent.

### Example 9

### Evaluation of the Property of the Heat-Insulating Material Manufactured for the Tests as Construction Material

The heat insulating construction was implemented in four detached houses (of the order of magnitude of about 200 m² and two storeys) with timber framing in Date City and Obihiro City in Hokkaido, using the heat-insulating material No. 4 from Example 1 manufactured for the tests and having a density of 55 kg/m³ and a commercially available glass wool heat-insulating material having a density of 16 kg/m³ and a thickness of 50 to 10 mm. The properties as construction material (processability, building-in rate and treatment of waste material) and the properties as residential material (heat insulation, sound damping and measure for healthy living) were evaluated. The evaluation was summarised by a building contractor and building owners in Table 8).

TABLE 8
Comparison of the evaluation of the property of
the heat-insulating material according to the invention and
the glass wool insulating material as construction material
and its suitability as residential material

| | | Heat-insulating | |
|---|---|---|---|
| | | material | Glass wool heat- |
| | | according to the | insulating |
| Evaluation points | | invention | material |
| Property as | Processability | Feeling of | Feeling of |
| construction | | sensation when | sensation when |
| material | | cutting and | cutting and |
| | | building in the | building in on |
| | | heat insulating | site. |
| | | material on | Processing is |
| | | site: good | tedious |
| | Building-in rate | Building-in rate | |
| | | approximately | |
| | | 1.5 times higher | |
| | | than that of | |
| | | glass wool | |
| | Treatment of | Edge parts are | Edge parts |
| | waste material | used for filling | accumulate as |
| | | gaps, little | waste for |
| | | accumulation of | disposal |
| | | waste material | |
| Property as | Heat insulation | Good. For the | Good |
| residential | | same thickness | |
| material | | better energy | |
| | | saving that for | |
| | | glass wool | |
| | Sound damping | Superior as | |
| | | sound damping; | |
| | | Superior as | |
| | | sound damping | |
| | | and impact sound | |
| | | damping as well | |
| | | as impact noise | |
| | | damping and | |
| | | damping of rain | |
| | | noise and | |
| | | knocking noise | |
| | VOC Unhealthy | Countermeasure | It is compulsory |
| | living | not required | to use type F |
| | | | from Forster as |
| | | | a measure |
| | | | against VOC |

The evaluation in Table 8 shows that the heat-insulating material manufactured for the tests is superior to the glass wool heat-insulating material both with regard to the property as a construction material and with regard to the property as a residential material.

### Example 10

### Manufacture of Heat-Insulating Felt

Raw material (A) in which the wood fibre (A-2) obtained by the additional addition of 0.5 wt. % of water-repelling agent to polydimethyl siloxane in No. 1 from Example 1 and the fibrous binder E were mixed in a ratio by weight of 50:50 and the raw material (B) in which they were mixed in a ratio of 80:20 were fibrillated by mixing with a carding machine and were fed into an air laying system of a dry paper machine to form fleeces A and B having a thickness of 5 mm and a weight per unit area of 750 g/m².

The fleeces A and B obtained were transferred to a double conveyor in the same way as in Example 1 and were compressed to 3 mm and wet adhesion and thermal fixing were carried out by steam moistening and heating with hot air. A commercially available nonwoven (TERRAMAC 50 g/m², made by Unitika Ltd.) was laminated and needling was carried out to form felts A and B.

The performance features achieved with the felts A and B obtained are shown in Table 9.

TABLE 9
Performance features of the heat-insulating
material according to the invention (felt)

| Unit of | | | |
|---|---|---|---|
| observation | Unit | Felt A | Felt B |
| Thickness | mm | 3 | 3 |
| Weight per unit | g/m² | 730 | 750 |
| area | | | |
| Thermal | W/mK | 0.045 | 0.045 |
| conductivity | | | |
| Tensile strength | Kg/20 mm Ø | 3.5 | 2.1 |
| Flexibility | Sensation of | Can be rolled up | Can be rolled up |
| | feel | easily | easily |

It can be seen from Table 9 that a heat-insulating and sound-damping felt which can be rolled up and which differs from mats and boards could be produced.

### Example 11

### Evaluation of the Adaptability During Press Forming

The forming and processing test of an uneven shape and a curved surface shape was carried out for felt A of Example 10 in order to confirm the adaptability as a formable material having heat and sound-damping properties, for example, as a material for the inner roof of a motor vehicle and as a floor insulator. The felt can be formed by wet adhesion and thermal fixing at a temperature of 150° C. and a pressing pressure of 1 to 10 Kg/cm² and the possibility for processing to form a three-dimensional structure and the press formability was confirmed.

### Example 12

### Evaluation of a Fleece for Agricultural Use and Natural Degradability

Fleece No. 4 from Example 1 contains N, P, K and B fertiliser components and no polluting substances in accordance with DIN 38409, EPA 610 and DIN-EN120 were detected. The fleece was furthermore used as plant cultivation matting and a fertilizer fleece for seeds such as rice and wheat, for fruit and vegetable such as tomatoes, cucumbers and aubergines, root vegetables such as greater burdock and for potatoes. The plant growth and the harvest are good without continuous damage to the planting.

Furthermore, the fleece was naturally degraded into earth over two to three months and it was confirmed that no negative factor regarding the activity of soil micro-organisms is present.

The heat-insulating material according to the invention is obtained by producing a mixture containing fibrous materials by a dry method and a semidry method. It creates a product having good properties such as flat appearance, flexibility, elasticity, and manageability of fleeces, boards and felts having a low density of 40 to 300 kg/m³.

With the fleeces and boards, it is possible to have an airtight heat insulating construction which possesses a heat-insulating property, thermal stress-relieving property and elasticity. The heat-insulating effect and the energy saving are better than those of a glass wool heat-insulating material, rock wool and a foam heat-insulating material.

Furthermore, the wood fibre treated with the heat insulation exhibits a flame-retardant and fire-resistant property and an appropriate ant-repelling effect.

With regard to the flame-retarding property and the fire resistance, the heat-insulating material exhibits a good flame-retardant property and fire resistance not comparable to glass wool, is more effective than semi-fire-resistant as a composite element with a construction board and allows the development of a new type of fire-resistant and heat-insulating construction material since the surface of the heat-insulating material forms a carbonised heat-insulating layer even if it is exposed to fire and heat.

Furthermore, the sound-insulating effect is very high, particularly in the low frequency range.

Since the heat-insulating material according to the present invention is a natural material and is composed of biologically degradable materials, the heat-insulating material does not pollute the environment as a waste material even it is left behind and is doubled with fertilizer components; thus, it can be used as cultivation matting and fertilizer fleece and at the same time exhibits an effect for activating forests and thinned-out timbers, including an environmental cleaning effect.

What is claimed is:

1. A biologically degradable heat-insulating material containing 50 to 90 wt. % of a cellulose and/or wood fibre having an average fibre diameter of 1 mm or less and an average fibre length of 20 mm or less, 2 to 15 wt. % of a flame-retardant agent as well as 5 to 30 wt. % of a biologically degradable binder in the form of bico fibres having an average fibre diameter of 1 mm or less and a fibre length of 20 mm or less, wherein the density of the heat-insulating material is 30 to 300 kg/m³.

2. A biologically degradable heat-insulating material containing 50 to 90 wt. % of a wood fibre having an average fibre diameter of 1 mm or less and an average fibre length of 20 mm or less, 2 to 15 wt. % of a flame-retardant and preferably ant-repellent agent having a fertilizer component and 5 to 30 wt. % of a biologically degradable binder having an average fibre diameter of 1 mm or less or a fineness of 10 dtex or less and a fibre length of 20 mm or less as main components, wherein the density of the heat-insulating material is 30 to 300 kg/m³ and wherein the heat-insulating material possesses a heat-insulating property, a thermal stress-relieving property, a sound-damping property, a fire-retarding property and a fire-resistance property, an ant-repelling property, a moisture regulating property as well as an environmental protection property and detoxification property.

3. The biologically degradable heat-insulating material according to claim 1, wherein the wood fibre is a staple fibre having an average fibre diameter of 1 mm or less and an average fibre length of 20 mm or less, which is obtained by damping and fibrillating thin timbers such as conifers, broad-leafed trees and monocotyledons, wood chips from old timbers, shavings of tough barks and/or sawmill residue.

4. The biologically degradable heat-insulating material according to claim 1, wherein the flame-retardant ant-repellent agent doubled with a fertilizer component contains the mixture of a boron compound and a phosphorus compound.

5. The biologically degradable heat-insulating material according to claim 1, wherein the biologically degradable heat-insulating material comprises synthetic and natural composite materials such as hot-water-soluble Poval, starch, CMC and chitosan and composite materials such as biologically degradable polyolefin, polyester and caprolactam and its fibres have an average fibre diameter of 1 mm or less or a fineness of 10 dtex or less and a fibre length of 20 mm or less.

6. The biologically degradable heat-insulating material according to claim 1, wherein the heat-insulating material has a fleece form, board form or felt form.

7. The biologically degradable heat-insulating material according to claim 1, wherein the heat-insulating material comprises a board form having a sandwich structure, the upper and lower layers whereof have a high density and in which a central core layer has a low density and wherein the average density of the heat-insulating material is 100 to 300 kg/m³.

8. The biologically degradable heat-insulating material according to claim 1, wherein the heat-insulating material is a board which is actually treated in order to improve its airtight insulating property, its airtight flame-retardant and fire-resistant property and its airtight sound-damping property.

9. The biologically degradable heat-insulating material according to claim 1, wherein the felt-like heat-insulating material is laminated on one or on both sides with a biologically degradable nonwoven having a weight per shot of 100 g/m² or less.

10. The biologically degradable heat-insulating material according to claim 1, which is used as cutting cultivating fleece or as fertilizer fleece which are manufactured from a nonwoven and a felt of heat-insulating material.

11. A method for producing a fleece or a board from the biologically degradable heat-insulating material according to claim 1, further comprising a dry process which includes mixing by dispersion, collecting and distributing the flocks and press forming and a semidry process which includes forming whilst moistening and forming whilst heating.

12. The method for producing a felt from the biologically degradable heat-insulating material according to claim 1, further comprising an air-laying dry process and semidry process including forming whilst moistening and forming whilst heating.

13. A method for producing wood fibres comprising the treatment of wood chips with the flame-retardant ant-repellent agent which is doubled with a fertilizer component and damping and fibrillating the wood chips in the biologically degradable heat-insulating material according to claim 1.

14. A press forming method for the secondary processing of the heat-insulating material according claim 1, further comprising the forming of a single-layer or multi-layer felt from a plurality of laminated layers of heat-insulating material by press forming whilst moistening and by forming whilst heating in order to produce a shaped body from the heat-insulating material or an acoustic material.
